(19) United States
(12) Patent Application Publication
(10) Pub. No.: US 2013/0269977 A1
(43) Pub. Date: Oct. 17, 2013

(54) Polyarylene Sulfide Composition Including a Functionalized Siloxane Polymer and a Non-Aromatic Impact Modifier

(71) Applicant: Ticona LLC, Florence, KY (US)

(72) Inventors: Rong Luo, Florence, KY (US); Xinyu Zhao, Cincinnati, OH (US)

(21) Appl. No.: 13/832,673

(22) Filed: Mar. 15, 2013

Related U.S. Application Data
(60) Provisional application No. 61/623,674, filed on Apr. 13, 2012.

(51) Int. Cl. C08L 81/04; H01B 3/30; B32B 1/08

(52) U.S. Cl. CPC C08L 81/04; B32B 1/08; H01B 3/301
USPC 174/110 SR; 525/101; 524/506; 428/36.92; 264/328.1; 264/523; 264/319; 264/41; 264/176.1; 264/164

(57) ABSTRACT

Polyarylene sulfide compositions are described as are methods of forming the polyarylene sulfide compositions. The polyarylene sulfide compositions are formed by melt processing polyarylene sulfide, a reactively functionalized siloxane polymer and a non-aromatic impact modifier. The non-aromatic impact modifier is, e.g., an ethylene-based copolymer or terpolymer or a silicone elastomer. The compositions exhibit good strength and heat resistance characteristics and can be utilized in forming a variety of products such as automotive components and electrical components.

### CROSS REFERENCE TO RELATED APPLICATION

The present application claims filing benefit of U.S. Provisional Patent Application Ser. No. 61/623,674 having a filing date of Apr. 13, 2012, which is incorporated herein by reference in its entirety.

### BACKGROUND OF THE INVENTION

Polyarylene sulfides are high-performance polymers that may withstand high thermal, chemical, and mechanical stresses and are beneficially utilized in a wide variety of applications. Polyarylene sulfides have often been blended with other materials to improve the characteristics of the product composition. For example, polyarylene sulfides are often compounded with fillers such as glass or mineral fillers to increase strength and stiffness. Such compositions, however, are still highly rigid, limiting application of the compositions. In an attempt to form polyarylene sulfide compositions with higher flexibility, elastomeric impact modifiers have been included in polyarylene sulfide compositions. Such blends have been formed in an attempt to improve the flexibility, elongation, and impact resistance of the compositions.

Unfortunately, while inclusion of elastomeric impact modifiers has provided some improvement in certain characteristics, other desirable characteristics of the polyarylene sulfide compositions have suffered. For instance, the inclusion of olefinic or acrylate rubbers to a polyarylene sulfide composition can deleteriously affect certain mechanical and thermal properties as well as chemical and flame resistance of the polyarylene sulfides with which they are incorporated. Moreover, polymers generally considered useful for impact modification are often not compatible with polyarylene sulfides and phase separation has been a problem in forming compositions including the two. Attempts have been made to improve the composition formation, for instance through the utilization of compatibilizers. However, even upon such modifications, compositions including polyarylene sulfides in combination with elastomeric impact modifying polymers still fail to provide product performance as may be desired, particularly in applications that require both high heat resistance and high impact resistance.

What is needed in the art are polyarylene sulfide compositions that exhibit improved characteristics, for instance a combination of heat resistance characteristics and impact resistance characteristics, so as to provide products suitable for use in a variety of applications.

### SUMMARY OF THE INVENTION

According to one embodiment, disclosed is a composition comprising a polyarylene sulfide, a reactively functionalized siloxane polymer, and an non-aromatic impact modifier. The composition can exhibit excellent physical characteristics including a tensile break strain of greater than about 25% as measured according to ISO Test No. 527 (technically equivalent to ASTM D638) at 23° C.

Also disclosed is a method of forming a composite. A method can include melt processing a polyarylene sulfide with a reactively functionalized siloxane polymer and a non-aromatic impact modifier. For instance, the non-aromatic impact modifier can be an ethylene-base copolymer or a silicone elastomer impact modifier.

The composition can beneficially be utilized in forming products such as, without limitation, fibers and fibrous products such as nonwoven fibrous mats, automotive components, electrical components, and tubular members such as may be utilized in high temperature applications, such as oil and gas pipelines.

### BRIEF DESCRIPTION OF THE FIGURES

The present disclosure may be better understood with reference to the following figures:

FIG. 1 illustrates a drawn fiber formation method as may be used in forming fibers of the polyarylene sulfide composition.

FIG. 2 illustrates a formation method for forming melt-blown fibers of the polyarylene sulfide composition.

FIG. 3 illustrates a fibrous mat as may incorporate polyarylene sulfide fibers as described herein.

FIG. 4 illustrates a tubular member as may be formed from the polyarylene sulfide composition.

FIG. 5 is a multi-layer tubular member, one or more layers of which may be formed from the polyarylene sulfide composition.

FIG. 6 illustrates a fuel tank as may be formed from the polyarylene sulfide composition.

FIG. 7 illustrates a sheathed wire (FIG. 7A) and a sheathed cable (FIG. 7B) incorporating the polyarylene sulfide composition as the sheathing material.

FIG. 8 illustrates a portable computer as may incorporate the polyarylene sulfide composition.

FIG. 9 illustrates another view of the portable computer of FIG. 8.

FIGS. 10A, 10B, 10C, and 10D present testing results for polyarylene sulfide compositions as described herein as compared to control compositions. Tested characteristics included notched Izod impact strength of a first set of samples (FIG. 10A), notched Izod impact strength of a second set of samples (FIG. 10B), tensile elongation of the first set of samples (FIG. 100), and tensile elongation of the second set of samples (FIG. 10D).

### DETAILED DESCRIPTION

It is to be understood by one of ordinary skill in the art that the present discussion is a description of exemplary embodiments only, and is not intended as limiting the broader aspects of the present disclosure.

The present disclosure is generally directed to polyarylene sulfide compositions including a polyarylene sulfide, a siloxane polymer, and a non-aromatic impact modifier. More specifically, the siloxane polymer utilized in forming the composition can be a reactively functionalized siloxane polymer. Beneficially, the compositions can include relatively small amounts of the reactively functionalized siloxane polymer, which can keep formation costs down while still providing extremely beneficial improvements to the polyarylene sulfide compositions. The disclosure is also directed to methods for forming the composition as well as applications in which the composition may beneficially be utilized.

Through combination of the particular components, i.e., the polyarylene sulfide, the reactively functionalized siloxane polymer, and the non-aromatic impact modifier, the formed composition can exhibit improved characteristics with regard to both strength and heat resistance as compared to previously known polyarylene sulfide compositions. As such, the polyarylene sulfide compositions can advantageously be utilized in a wide variety of applications including, without limitation, automotive components, storage containers and piping as may be utilized with high temperature and/or flammable fluids, wire and cable sheathing, as well as in other applications that can utilize extruded, drawn, or spun articles such as fibers, filaments, and films formed from the compositions.

The improved characteristics of the polyarylene sulfide composition can be determined through measurement of one or more physical characteristics of the composition. For instance, the Izod unnotched impact strength of the polyarylene sulfide composition may be greater than about 30 kJ/m², greater than about 40 kJ/m², or greater than about 50 kJ/m² as measured at 23° C. according to ISO Test No. 180/1 U. The Izod notched impact strength of the polyarylene sulfide composition may be greater than about 40 kJ/m², or greater than about 42 kJ/m² as measured at 23° C. according to ISO Test No. 180/1 A.

The tensile strength characteristics of the polyarylene sulfide composition can also be very good. For example, the tensile break strain of the polyarylene sulfide composition can be greater than about 25%, greater than about 50%, or greater than about 60%. The tensile elongation of greater than about 30%, greater than about 40%, or greater than about 50%. Tensile strength characteristics can be determined according to ISO Test No. 527 (technically equivalent to ASTM D638) at 23° C.

The polyarylene sulfide composition can also exhibit good flexibility. For instance the polyarylene sulfide composition can exhibit a flexural modulus of less than about 2450 MPa, or less than about 2425 MPa, and can exhibit a flexural break stress of less than about 70 MPa, or less than about 69.5 MPa. Flexural properties can be determined according to ISO Test No. 178 (technically equivalent to ASTM D790). The polyarylene sulfide composition can also exhibit a deflection temperature under load of less than about 97° C. as determined according to IST Test No. 75-2.

The polyarylene sulfide composition can also exhibit good heat resistance and flame retardant characteristics. For instance, a polyarylene sulfide composition that includes a silicone elastomer as an impact modifier can meet the V-0 flammability standard at a thickness of 0.2 millimeters. The flame retarding efficacy may be determined according to the UL 94 Vertical Burn Test procedure of the “Test for Flammability of Plastic Materials for Parts in Devices and Appliances”, 5th Edition, Oct. 29, 1996. The ratings according to the UL 94 test are listed in the following table:

| Rating | Afterflame Time (s) | Burning Drips | Burn to Clamp |
|---|---|---|---|
| V-0 | <10 | No | No |
| V-1 | <30 | No | No |
| V-2 | <30 | Yes | No |
| Fail | <30 | | Yes |
| Fail | >30 | | No |

The “afterflame time” is an average value determined by dividing the total afterflame time (an aggregate value of all samples tested) by the number of samples. The total afterflame time is the sum of the time (in seconds) that all the samples remained ignited after two separate applications of a flame as described in the UL-94 VTM test. Shorter time periods indicate better flame resistance, i.e., the flame went out faster. For a V-0 rating, the total afterflame time for five (5) samples, each having two applications of flame, must not exceed 50 seconds. Using the flame retardant of the present invention, articles may achieve at least a V-1 rating, and typically a V-0 rating, for specimens having a thickness of 0.8 millimeters.

The polyarylene sulfide may be a polyarylene thioether containing repeat units of the formula (I):

—[(Ar¹)ₙ—X]ₘ—[(Ar²)ᵢ—Y]ⱼ—[(Ar³)ₖ—Z]ᵢ—[(Ar⁴)ₒ—W]ₚ— (I)

wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, l, o, and p are independently zero or 1, 2, 3, or 4, subject to the proviso that their sum total is not less than 2. The arylene units Ar¹, Ar², Ar³, and Ar⁴ may be selectively substituted or unsubstituted. Advantageous arylene systems are phenylene, biphenylene, naphthylene, anthracene and phenanthrene. The polyarylene sulfide typically includes more than about 30 mol %, more than about 50 mol %, or more than about 70 mol % arylene sulfide (—S—) units. In one embodiment the polyarylene sulfide includes at least 85 mol % sulfide linkages attached directly to two aromatic rings.

In one embodiment, the polyarylene sulfide is a polyphenylene sulfide, defined herein as containing the phenylene sulfide structure —(C₆H₄—S)ₓ— (wherein x is an integer of 1 or more) as a component thereof.

The polyarylene sulfide may be synthesized prior to forming the polyarylene sulfide composition, though this is not a requirement of a process, and a polyarylene sulfide can also be purchased from known suppliers. For instance Fortron® polyphenylene sulfide available from Ticona of Florence, Ky., USA can be purchased and utilized as the polyarylene sulfide.

Synthesis techniques that may be used in making a polyarylene sulfide are generally known in the art. By way of example, a process for producing a polyarylene sulfide can include reacting a material that provides a hydrosulfide ion, e.g., an alkali metal sulfide, with a dihaloaromatic compound in an organic amide solvent.

The alkali metal sulfide can be, for example, lithium sulfide, sodium sulfide, potassium sulfide, rubidium sulfide, cesium sulfide or a mixture thereof. When the alkali metal sulfide is a hydrate or an aqueous mixture, the alkali metal sulfide can be processed according to a dehydrating operation in advance of the polymerization reaction. An alkali metal sulfide can also be generated in situ. In addition, a small amount of an alkali metal hydroxide can be included in the reaction to remove or react impurities (e.g., to change such impurities to harmless materials) such as an alkali metal polysulfide or an alkali metal thiosulfate, which may be present in a very small amount with the alkali metal sulfide.

The dihaloaromatic compound can be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds can include, without limitation, p-dichlorobenzene; m-dichlorobenzene; o-dichlorobenzene; 2,5-dichlorotoluene; 1,4-dibromobenzene; 1,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone.

The halogen atom can be fluorine, chlorine, bromine or iodine, and 2 halogen atoms in the same dihalo-aromatic compound may be the same or different from each other. In one embodiment, o-dichlorobenzene, m-dichlorobenzene, p-dichlorobenzene or a mixture of 2 or more compounds thereof is used as the dihalo-aromatic compound.

As is known in the art, it is also possible to use a monohalo compound (not necessarily an aromatic compound) in combination with the dihaloaromatic compound in order to form end groups of the polyarylene sulfide or to regulate the polymerization reaction and/or the molecular weight of the polyarylene sulfide.

The polyarylene sulfide may be a homopolymer or may be a copolymer. By a suitable, selective combination of dihaloaromatic compounds, a polyarylene sulfide copolymer can be formed containing not less than two different units. For instance, in the case where p-dichlorobenzene is used in combination with m-dichlorobenzene or 4,4′-dichlorodiphenylsulfone, a polyarylene sulfide copolymer can be formed containing segments having the structure of formula (II):

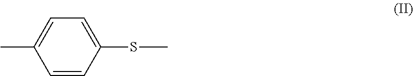

and segments having the structure of formula (III):

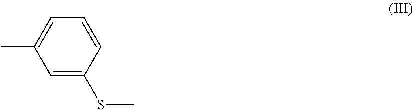

or segments having the structure of formula (IV):

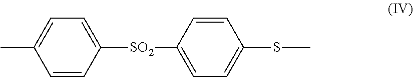

In general, the amount of the dihaloaromatic compound(s) per mole of the effective amount of the charged alkali metal sulfide can generally be from 1.0 to 2.0 moles, from 1.05 to 2.0 moles, or from 1.1 to 1.7 moles. Thus, the polyarylene sulfide can include alkyl halide (generally alkyl chloride) end groups.

A process for producing the polyarylene sulfide can include carrying out the polymerization reaction in an organic amide solvent. Exemplary organic amide solvents used in a polymerization reaction can include, without limitation, N-methyl-2-pyrrolidone; N-ethyl-2-pyrrolidone; N,N-dimethylformamide; N,N-dimethylacetamide; N-methylcaprolactam; tetramethylurea; dimethylimidazolidinone; hexamethyl phosphoric acid triamide and mixtures thereof. The amount of the organic amide solvent used in the reaction can be, e.g., from 0.2 to 5 kilograms per mole (kg/mol) of the effective amount of the alkali metal sulfide.

The polymerization can be carried out by a step-wise polymerization process. The first polymerization step can include introducing the dihaloaromatic compound to a reactor, and subjecting the dihaloaromatic compound to a polymerization reaction in the presence of water at a temperature of from about 180° C. to about 235° C., or from about 200° C. to about 230° C., and continuing polymerization until the conversion rate of the dihaloaromatic compound attains to not less than about 50 mol % of the theoretically necessary amount.

In a second polymerization step, water is added to the reaction slurry so that the total amount of water in the polymerization system is increased to about 7 moles, or to about 5 moles, per mole of the effective amount of the charged alkali metal sulfide. Following, the reaction mixture of the polymerization system can be heated to a temperature of from about 250° C. to about 290° C., from about 255° C. to about 280° C., or from about 260° C. to about 270° C. and the polymerization can continue until the melt viscosity of the thus formed polymer is raised to the desired final level of the polyarylene sulfide. The duration of the second polymerization step can be, e.g., from about 0.5 to about 20 hours, or from about 1 to about 10 hours.

The polyarylene sulfide may be linear, semi-linear, branched or crosslinked. A linear polyarylene sulfide includes as the main constituting unit the repeating unit of —(Ar—S) —. In general, a linear polyarylene sulfide may include about 80 mol % or more of this repeating unit. A linear polyarylene sulfide may include a small amount of a branching unit or a cross-linking unit, but the amount of branching or cross-linking units may be less than about 1 mol % of the total monomer units of the polyarylene sulfide. A linear polyarylene sulfide polymer may be a random copolymer or a block copolymer containing the above-mentioned repeating unit.

A semi-linear polyarylene sulfide may be utilized that may have a cross-linking structure or a branched structure provided by introducing into the polymer a small amount of one or more monomers having three or more reactive functional groups. For instance between about 1 mol % and about 10 mol % of the polymer may be formed from monomers having three or more reactive functional groups. Methods that may be used in making semi-linear polyarylene sulfide are generally known in the art. By way of example, monomer components used in forming a semi-linear polyarylene sulfide can include an amount of polyhaloaromatic compounds having 2 or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, and the like, and mixtures thereof.

Following polymerization, the polyarylene sulfide may be washed with liquid media. For instance, the polyarylene sulfide may be washed with water, acetone, N-methyl-2-pyrrolidone, a salt solution, and/or an acidic media such as acetic acid or hydrochloric acid prior to combination with other components while forming the mixture. The polyarylene sulfide can be washed in a sequential manner that is generally known to persons skilled in the art, for instance with an organic solvent that will not decompose the polyarylene sulfide. Washing with an acidic solution or a salt solution may reduce the sodium, lithium or calcium metal ion end group concentration from about 2000 ppm to about 100 ppm. A polyarylene sulfide can be subjected to a hot water washing process. The temperature of a hot water wash can be at or above about 100° C., for instance higher than about 120° C., higher than about 150° C., or higher than about 170° C. In one embodiment, organic solvent washing can be combined with hot water washing and/or warm water washing. When a high-boiling-point organic solvent such as N-methylpyrrolidone is used, the residual organic solvent can be removed by washing with water or warm water after the organic solvent washing, and distilled water or deionized water can be used for this washing.

The polymerization reaction apparatus for forming the polyarylene sulfide is not especially limited, although it is typically desired to employ an apparatus that is commonly used in formation of high viscosity fluids. Examples of such a reaction apparatus may include a stirring tank type polymerization reaction apparatus having a stirring device that has a variously shaped stirring blade, such as an anchor type, a multistage type, a spiral-ribbon type, a screw shaft type and the like, or a modified shape thereof. Further examples of such a reaction apparatus include a mixing apparatus commonly used in kneading, such as a kneader, a roll mill, a Banbury mixer, etc. Following polymerization, the molten polyarylene sulfide may be discharged from the reactor, typically through an extrusion orifice fitted with a die of desired configuration, cooled, and collected. Commonly, the polyarylene sulfide may be discharged through a perforated die to form strands that are taken up in a water bath, pelletized and dried. The polyarylene sulfide may also be in the form of a strand, granule, or powder.

The polyarylene sulfide composition may include the polyarylene sulfide component (which also encompasses a blend of polyarylene sulfides) in an amount from about 10 wt. % to about 99 wt. % by weight of the composition, for instance from about 20% wt. % to about 90 wt. % by weight of the composition.

The polyarylene sulfide may be of any suitable molecular weight and melt viscosity, generally depending upon the final application intended for the polyarylene sulfide composition and the processing methodology to be used in forming the composition. For instance, the polyarylene sulfide may be a low viscosity material, having a melt viscosity of less than about 500 poise, a medium viscosity polyarylene sulfide, having a melt viscosity of between about 500 poise and about 1500 poise, or a high melt viscosity polyarylene sulfide, having a melt viscosity of greater than about 1,500 poise. In one embodiment, the polyarylene sulfide may have a number average molecular weight greater than about 25,000 g/mol, or greater than about 30,000 g/mol, and a weight average molecular weight greater than about 60,000 g/mol, or greater than about 65,000 g/mol. Melt viscosity may be determined in accordance with ISO Test No. 11443 at a shear rate of 1200 s⁻¹ and at a temperature of 310° C.

In one embodiment, the polyarylene sulfide can be melt processed with a disulfide compound. Reaction between the polyarylene sulfide and the disulfide compound can cause chain scission of the polyarylene sulfide, which can decrease the melt viscosity of the polyarylene sulfide and improve processing conditions and product characteristics. For example, in those embodiments in which the polyarylene sulfide is a high molecular weight, low halogen content polyarylene sulfide, reaction with a disulfide can decrease the molecular weight (melt viscosity) of the polymer, while maintaining the low halogen content. Thus, the composition can exhibit excellent processibility and low halogen content. A low halogen content polyarylene sulfide can generally have a halogen content of less than about 1000 ppm, less than about 900 ppm, less than about 600 ppm, or less than about 400 ppm.

The disulfide compound can optionally include reactive functionality. In this embodiment, reaction between the polyarylene sulfide and the disulfide compound can also provide the reactive functionality of the disulfide compound to the polyarylene sulfide, which can lead to further improved interaction between components of the composition. For example, reactive functionality of the polyarylene sulfide can lead to increased bonding between the polyarylene sulfide and other components of the composition.

When utilized, the disulfide compound may generally have the structure of formula (V):

R₁—S—S—R₂ (V)

wherein R₁ and R₂ may be the same or different and are hydrocarbon groups that independently include from 1 to about 20 carbons. For instance, R₁ and R₂ may be an alkyl, cycloalkyl, aryl, or heterocyclic group.

In addition, at least one of R₁ and R₂ may include reactive functionality at terminal end(s) of the disulfide compound. For example, at least one of R₁ and R₂ may include a terminal carboxyl group, hydroxyl group, a substituted or non-substituted amino group, a nitro group, or the like. Examples of disulfide compounds including reactive terminal groups as may be combined with a starting polyarylene sulfide may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid, dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole) and 2-(4′-morpholinodithio)benzothiazole.

The disulfide compound may include nonreactive functionality at terminal end(s). For instance, the R₁ and R₂ groups may be the same or different and may be nonreactive groups independently selected from the group consisting of alkyl, cycloalkyl, aryl, and heterocyclic groups of 1 to about 20 carbon atoms. Examples of disulfide compounds including nonreactive terminal groups as may be combined with a polyarylene sulfide may include, without limitation, diphenyl disulfide, naphthyl disulfide, dimethyl disulfide, diethyl disulfide, and dipropyl disulfide.

The ratio of the amount of the polyarylene sulfide to the amount of the disulfide compound can be from about 1000:1 to about 10:1, from about 500:1 to about 20:1, or from about 400:1 to about 30:1. In one embodiment, enough of the reactively functionalized disulfide compound can be added to the polyarylene sulfide so as to develop a desired melt viscosity of the polyarylene sulfide composition. However, excessive disulfide compound added to the polyarylene sulfide can lead to undesired interaction between the excess reactively functionalized disulfide compound and other components during formation of the polyarylene sulfide composition.

In combination with the polyarylene sulfide, the composition can include a reactively functionalized siloxane polymer. The reactively functionalized siloxane polymer can encompass any polymer, co-polymer or oligomer that includes siloxane units in the backbone having the formula:

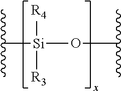

wherein R₃ and R₄ are independently of one another, hydrogen, alkyl, alkenyl, acyl, alkaryl or aralkyl having up to 20 carbon atoms and wherein the siloxane polymer includes reactive functionality on at least a portion of the siloxane monomer units of the polymer. The backbone of the siloxane polymer can include substitutions as is known in the art such as alkyl substitutions, phenyl substitutions, etc.

Some examples of suitable siloxane polymers include, without limitation, polydimethyl siloxanes such as dimethylvinylsiloxy end group-capped polydimethyl siloxane, methyldivinylsiloxy end group-capped polydimethyl siloxane, dimethylvinylsiloxy end group-capped dimethyl siloxane, (80 mol %)/methylphenylsiloxane (20 mol %) copolymers, dimethylvinylsiloxy end group-capped dimethylsiloxane (80 mol %)/diphenylsiloxane (20 mol %) copolymers, dimethylvinylsiloxy end group-capped dimethylsiloxane (90 mol %)/diphenylsiloxane (10 mol %) copolymers, and trimethylsiloxy end group-capped dimethylsiloxane/methylvinylsiloxane copolymers. Besides the above-mentioned polymers, other polymers may also be utilized. For instance, some suitable vinyl-modified silicones include, but are not limited to, vinyldimethyl terminated polydimethylsiloxanes; vinylmethyl, dimethylpolysiloxane copolymers; vinyldimethyl terminated vinylmethyl, dimethylpolysiloxane copolymers; divinylmethyl terminated polydimethylsiloxanes; polydimethylsiloxane, mono vinyl, mono n-butyldimethyl terminated; and vinylphenylmethyl terminated polydimethylsiloxanes. Further, some methyl-modified silicones that can be used include, but are not limited to, dimethylhydro terminated polydimethylsiloxanes; methylhydro, dimethylpolysiloxane copolymers; methylhydro terminated methyloctyl siloxane copolymers; and methylhydro, phenylmethyl siloxane copolymers.

The reactive functionality of the siloxane polymer can include, without limitation, one or more of vinyl groups, hydroxyl groups, hydrides, isocyanate groups, epoxy groups, acid groups, halogen atoms, alkoxy groups (e.g., methoxy, ethoxy and propoxy), acyloxy groups (e.g., acetoxy and octanoyloxy), ketoximate groups (e.g., dimethylketoxime, methylketoxime and methylethylketoxime), amino groups (e.g., dimethylamino, diethylamino and butylamino), amido groups (e.g., N-methylacetamide and N-ethylacetamide), acid amido groups, amino-oxy groups, mercapto groups, alkenyloxy groups (e.g., vinyloxy, isopropenyloxy, and 1-ethyl-2-methylvinyloxy), alkoxyalkoxy groups (e.g., methoxyethoxy, ethoxyethoxy and methoxypropoxy), aminoxy groups (e.g., dimethylaminoxy and diethylaminoxy), mercapto groups, and the like.

The siloxane polymers can be linear or crosslinked, and can have any desired molecular weight. For example, in one embodiment, the reactively functionalized siloxane polymer can have a molecular weight of greater than about 5000. In general, however, the siloxane polymers will not be of a size or crosslink density that would lead to formation of a separate phase in the composition, e.g., a particle formed of the siloxane polymer. By way of example, in one embodiment, the reactively functionalized siloxane polymer can include a polydimethylsiloxane backbone and have more than 200 —(CH₃)₂SiO— repeating units along the backbone.

In one embodiment, the siloxane polymer can be epoxy-functionalized and can include epoxy groups incorporated into the siloxane polymer having the formula:

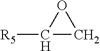

wherein R₅ is a divalent aliphatic (C₁-C₁₀), cycloalkyl(C₅-C₂₀) heterocyclic (C₄-C₉), substituted or unsubstituted aromatic (C₆-C₉) hydrocarbon radical or a direct bond.

In one embodiment, the epoxy groups can be incorporated onto an amine-functionalized or amino-terminated siloxane. For instance, an amine-terminated siloxane polymer such as those available commercially as the “G series” siloxane resins available from the General Electric Company can be reactively functionalized with epoxy. Epoxy functionalization may be carried out via reaction with an epoxy-containing compound such as an epoxy chlorotriazine as is known.

One example of a suitable epoxy chlorotriazine as may be utilized is trimethylglycidyl cyanuric chloride.

Reaction between the epoxy chlorotriazine and the siloxane may be conducted in an organic solvent such as toluene, methylene chloride, or other organic liquid of similar polarity. Reaction temperatures in the range of about 20° C. to about 100° C. may be employed. Excess amounts of the epoxy chlorotriazine are typically employed, which fall in the range of between about 1% and about 6% or between about 2% and about 6% by weight of the siloxane polymer.

In one embodiment, the siloxane polymer can be mercapto-functionalized and can include mercapto groups incorporated into the siloxane polymer having the formula:

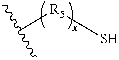

wherein R₅ is as described above. For example, the siloxane polymer can be a mercapto-functionalized polydimethyl siloxane having the general formula:

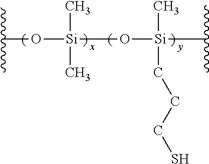

Beneficially, a relatively small amount of the reactively functionalized siloxane polymer can be incorporated into the polyarylene sulfide composition, which can be very cost effective. Even with a small amount of the reactively functionalized siloxane polymer, the polyarylene sulfide composition can exhibit excellent mechanical and heat resistance characteristics. For example, the polyarylene sulfide composition can include less than 10 A % by weight of the reactively functionalized siloxane polymer. In one embodiment, the composition can include from about 0.1% to about 2.5%, or from about 1% to about 2% of the reactively functionalized siloxane polymer.

In addition to the polyarylene sulfide and the reactively functionalized siloxane polymer, the composition also includes a non-aromatic impact modifier. As utilized herein, the term “non-aromatic impact modifier” generally refers to an impact modifier that includes no aromatic groups on the backbone of the polymer. For instance, the non-aromatic impact modifier is not derived from vinyl aromatic monomers polymerized to form an impact modifier. It should be understood, however, that a non-aromatic impact modifier may include an aromatic group on a side chain of the polymer in one embodiment and, in another embodiment, the non-aromatic impact modifier can be free of aromatic groups.

In one embodiment, the non-aromatic impact modifier can be an ethylene copolymer or terpolymer or an ethylene propylene copolymer or terpolymer. By way of example, the non-aromatic impact modifier can include ethylenically unsaturated monomer units have from about 4 to about 10 carbon atoms. In addition, the non-aromatic impact modifier can be modified with a mole fraction of from about 0.01 to about 0.5 of one or more of the following: an α, β unsaturated dicarboxylic acid or salt thereof having from about 3 to about 8 carbon atoms; an α, β unsaturated carboxylic acid or salt thereof having from about 3 to about 8 carbon atoms; an anhydride or salt thereof having from about 3 to about 8 carbon atoms; a monoester or salt thereof having from about 3 to about 8 carbon atoms; a sulphonic acid or a salt thereof; an unsaturated epoxy compound having from about 4 to about 11 carbon atoms. Examples of such modification functionalities include maleic anhydride, fumaric acid, maleic acid, methacrylic acid, acrylic acid, and glycidyl methacrylate. Examples of metallic acid salts include the alkaline metal and transitional metal salts such as sodium, zinc, and aluminum salts.

A non-limiting listing of such non-aromatic impact modifiers that may be used include ethylene-acrylic acid copolymer, ethylene-maleic anhydride copolymers, ethylene-alkyl (meth)acrylate-maleic anhydride terpolymers, ethylene-alkyl (meth)acrylate-glycidyl (meth)acrylate terpolymers, ethylene-acrylic ester-methacrylic acid terpolymer, ethylene-acrylic ester-maleic anhydride terpolymer, ethylene-methacrylic acid-methacrylic acid alkaline metal salt (ionomer) terpolymers, etc. In one embodiment, for instance, the impact modifier can be a random terpolymer of ethylene, methylacrylate, and glycidyl methacrylate. The terpolymer can have a glycidyl methacrylate content of from about 5% to about 20%, such as from about 6% to about 10%. The terpolymer may have a methylacrylate content of from about 20% to about 30%, such as about 24%.

The impact modifier may be linear or branched, may be a homopolymer or copolymer (e.g., random, graft, block, etc.), and may contain epoxy functionalization in any portion of the polymer, e.g., terminal epoxy groups, skeletal oxirane units, and/or pendent epoxy groups. For instance, the impact modifier may be a copolymer including at least one monomer component that includes epoxy functionalization. The monomer units of the impact modifier may vary. In one embodiment, for example, the impact modifier can include epoxy-functional methacrylic monomer units. As used herein, the term methacrylic generally refers to both acrylic and methacrylic monomers, as well as salts and esters thereof, e.g., acrylate and methacrylate monomers. Epoxy-functional methacrylic monomers as may be incorporated in the impact modifier may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate.

Other monomer units may additionally or alternatively be a component of the impact modifier. Examples of other monomers may include, for example, ester monomers, olefin monomers, amide monomers, etc. In one embodiment, the non-aromatic impact modifier can include at least one linear or branched α-olefin monomer, such as those having from 2 to 20 carbon atoms, or from 2 to 8 carbon atoms. Specific examples include ethylene; propylene; 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene.

Monomers included in an impact modifier that includes epoxy functionalization can include monomers that do not include epoxy functionalization, as long as at least a portion of the monomer units of the polymer are epoxy functionalized.

In one embodiment, the impact modifier can be a terpolymer that includes epoxy functionalization. For instance, the impact modifier can include a methacrylic component that includes epoxy functionalization, an α-olefin component, and a methacrylic component that does not include epoxy functionalization. For example, the impact modifier may be poly(ethylene-co-methylacrylate-co-glycidyl methacrylate), which has the following structure:

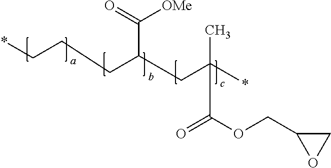

wherein, a, b, and c are 1 or greater.

The relative proportion of the various monomer components of a copolymeric impact modifier is not particularly limited. For instance, in one embodiment, the epoxy-functional methacrylic monomer components can form from about 1 wt. % to about 25 wt. %, or from about 2 wt. ° AD to about 20 wt % of a copolymeric non-aromatic impact modifier. An α-olefin monomer can form from about 55 wt. % to about 95 wt. %, or from about 60 wt. % to about 90 wt. %, of a copolymeric non-aromatic impact modifier. When employed, other monomeric components (e.g., a non-epoxy functional methacrylic monomers) may constitute from about 5 wt. % to about 35 wt. %, or from about 8 wt. % to about 30 wt. %, of a compolymeric non-aromatic impact modifier.

An impact modifier may be formed according to standard polymerization methods as are generally known in the art. For example, a monomer containing polar functional groups may be grafted onto a polymer backbone to form a graft copolymer. Alternatively, a monomer containing functional groups may be copolymerized with a monomer to form a block or random copolymer using known free radical polymerization techniques, such as high pressure reactions, Ziegler-Natta catalyst reaction systems, single site catalyst (e.g., metallocene) reaction systems, etc.

Alternatively, an impact modifier may be obtained on the retail market. By way of example, suitable compounds for use as an ethylene-base copolymer impact modifier may be obtained from Arkema under the name Lotader®.

The non-aromatic impact modifier is not limited to an ethylene copolymers or terpolymers, however, and other non-aromatic impact modifiers may be included in the polyarylene sulfide composition in addition to or alternative to such impact modifiers. For example, silicone elastomer (i.e., a silicone rubber) non-aromatic impact modifier can be included in the polyarylene sulfide compositions.

Illustrative silicone elastomers may comprise polydiorganosiloxanes such as polydimethylsiloxane. For example, a silicone elastomer can be a polydimethylsiloxane that can be terminated with, e.g., hydroxyl, or vinyl functionality. In one embodiment, the silicone elastomer can include at least 2 alkenyl groups having 2 to 20 carbon atoms. The alkenyl group can include, for example, vinyl, allyl, butenyl, pentenyl, hexenyl and decenyl. The position of the alkenyl functionality is not critical and it may be bonded at the molecular chain terminals, in non-terminal positions on the molecular chain, or at both positions. In general, the alkenyl functionality can be present at a level of 0.001 to 3 weight percent, preferably 0.01 to 1 weight percent, of the silicone elastomer. In one embodiment, the silicone elastomer impact modifier is a polydimethylsiloxane homopolymer that is terminated with a hydroxyl or a vinyl group at each end and optionally that also contains at least one vinyl group along its main chain.

Other, organic groups of the silicone elastomer impact modifier can be independently selected from hydrocarbon or halogenated hydrocarbon groups that contain no aliphatic unsaturation. These can be exemplified by alkyl groups having 1 to 20 carbon atoms, such as methyl, ethyl, propyl, butyl, pentyl and hexyl; cycloalkyl groups, such as cyclohexyl and cycloheptyl; and halogenated alkyl groups having 1 to 20 carbon atoms, such as 3,3,3-trifluoropropyl and chloromethyl. It will be understood that these groups are selected such that the silicone elastomer has a glass transition temperature (or melt point) that is below room temperature and as such is therefore elastomeric.

The silicone elastomer impact modifier can be a homopolymer or a copolymer. The molecular structure is also not critical and is exemplified by straight-chain and partially branched straight-chains.

Specific illustrations of silicone elastomer non-aromatic impact modifiers can include, without limitation, trimethylsiloxy-endblocked dimethylsiloxane-methylhexenylsiloxane copolymers; dimethylhexenlylsiloxy-endblocked dimethylsiloxane-methylhexenylsiloxane copolymers; trimethylsiloxy-endblocked dimethylsiloxane-methylvinylsiloxane copolymers; dimethylvinylsiloxy-endblocked dimethylsiloxane-methylvinylsiloxane copolymers; and similar copolymers wherein at least one end group is dimethylhydroxysiloxy.

The molecular weight of the non-aromatic impact modifier can vary widely. For example, the non-aromatic impact modifier can have a number average molecular weight from about 7,500 to about 250,000 grams per mole, in some embodiments from about 15,000 to about 150,000 grams per mole, and in some embodiments, from about 20,000 to 100,000 grams per mole, with a polydispersity index typically ranging from 2.5 to 7.

In general, the non-aromatic impact modifier may be present in the composition in an amount from about 0.05% to about 25% by weight, such as in an amount from about 0.1% to about 15% by weight.

In addition to the polyarylene sulfide, the reactively functionalized siloxane polymer, and the non-aromatic impact modifier, the polyarylene sulfide composition can include one or more additives as are generally known in the art. For example, the composition can include one or more fillers such as a fibrous filler and/or a mineral filler. A filler may generally be included in the polyarylene sulfide composition in an amount of from about 5% to about 70%, or from about 20% to about 65% by weight of the composition. When present, fiber of a fibrous filler are typically of a length from about 0.5 mm to about 5.0 mm. A fibrous filler may include one or more fiber types including, without limitation, polymer fibers, glass fibers, carbon fibers, metal fibers, and so forth, or a combination of fiber types. In one embodiment, the fibers may be chopped glass fibers or glass fiber rovings (tows).

Glass fibers may be made from suitable ingredients or raw materials (e.g., sand for SiO₂, burnt lime for CaO, dolomite for MgO), which can be mixed or blended in a conventional manner in the appropriate quantities to give the desired weight percentages of the final composition. The mixed batch can then be melted in a furnace or melter, and the resulting molten glass can be passed along a forehearth and into fiber-forming bushings located along the bottom of the forehearth. The molten glass can be pulled or drawn through holes or orifices in the bottom or tip plate of the bushing to form glass fibers. The streams of molten glass flowing through the bushing orifices can be attenuated to filaments by winding a strand of the filaments on a forming tube mounted on a rotatable collet of a winding machine. The fibers may be further processed in a conventional manner suitable for the intended application. For example, the fibers may be pretreated with a sizing that may facilitate mixing with the other components of the polyarylene sulfide composition during melt processing.

Fiber diameters can vary depending upon the particular fiber used and are available in either chopped or continuous form. The fibers, for instance, can have a diameter of less than about 100 μm, such as less than about 50 μm. For instance, the fibers can be chopped or continuous fibers and can have a fiber diameter of from about 5 μm to about 50 μm, such as from about 5 μm to about 15 μm. Fiber lengths can vary. In one embodiment, the fibers can have an initial length of from about 3 mm to about 5 mm.

In one embodiment, the fibers may have a high yield or small K numbers. The tow is indicated by the yield or K number. For instance, glass fiber tows may have 50 yield and up, for instance from about 115 yield to about 1200 yield.

One or more mineral fillers can be included in the polyarylene sulfide composition. For instance, the composition can include one or more mineral fillers in an amount of from about 1 wt. % to about 50 wt. % of the composition. Mineral fillers may include, without limitation, silica, quartz powder, silicates such as calcium silicate, aluminum silicate, kaolin, talc, mica, clay, diatomaceous earth and wollastonite, and so forth.

Still other additives that can be included in the polyarylene sulfide composition can encompass, without limitation, antimicrobials, pigments, lubricants, antioxidants, stabilizers, surfactants, waxes, flow promoters, solid solvents, and other materials added to enhance properties and/or the processibility of the composition. Such optional materials may be employed in a composition in conventional amounts.

The polyarylene sulfide composition may be formed in a single step melt processing process in which all of the components, e.g., the polyarylene sulfide, the reactively functionalized siloxane polymer and the non-aromatic impact modifier are combined in a melt processing apparatus, such as an extruder. Alternatively, a composition may be formed in a multi-step process. For instance, the polyarylene sulfide and the reactively functionalized siloxane polymer may be combined in a first melt processing step, and the non-aromatic impact modifier and one or more additives may be combined with the mixture containing the polyarylene sulfide and the reactively functionalized siloxane polymer in one or more subsequent steps.

The components may be melt processed according to techniques known in the art. For example, the components of the polyarylene sulfide composition may be melt-kneaded in a single-screw or multi-screw extruder at a temperature of from about 250° C. to about 320° C. In one embodiment, the composition may be melt processed in an extruder that includes multiple temperature zones. For instance, the composition may be melt processed in an extruder that includes a temperature zone that is maintained at a temperature of between about 250° C. and about 320° C.

In one embodiment, the polyarylene sulfide composition may be utilized in forming fibers, films, coatings, and the like. By way of example, continuous or discontinuous fibers exhibiting high strength and heat resistant qualities can be formed of the polyarylene sulfide composition. Such fibers may be beneficially utilized in forming woven or non-woven mats for use in, e.g., filtration materials, insulation materials, etc.

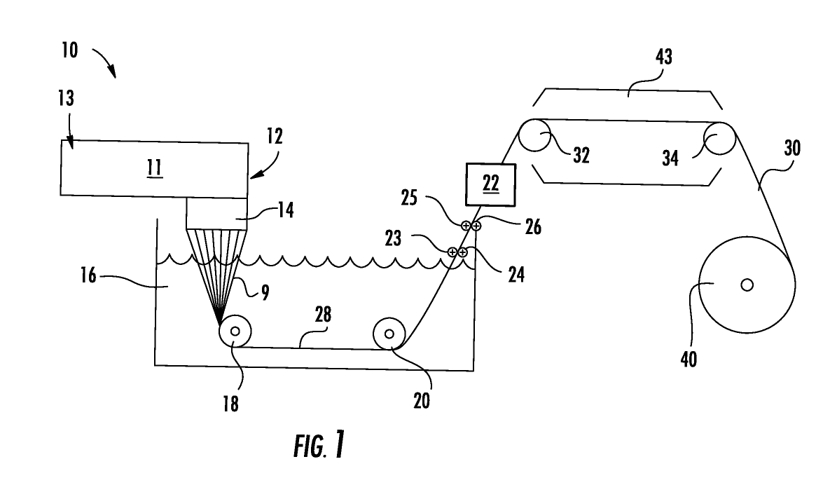

The polyarylene sulfide composition can be spun to form staple, continuous, multifilament, or monofilament fiber using conventional melt spinning equipment. By way of example, FIG. 1 illustrates a process and system 10 by which a drawn fiber may be formed of the polyarylene sulfide composition. According to the illustrated embodiment, the previously formed polyarylene sulfide composition, for instance in the form of pellets or chips, can be provided to an extruder apparatus 12. The extruder apparatus 12 can include a mixing manifold 11 in which the polyarylene composition can be heated to form a molten composition and optionally mixed with any additional additives. If desired, to help ensure the fluid state of the molten mixture, the molten mixture can be filtered prior to extrusion. For example, the molten mixture can be filtered to remove any fine particles from the mixture by use of a filter with about 325 mesh or finer. Alternatively, the polyarylene sulfide composition can be formed in the mixing manifold 11. For instance, the polyarylene sulfide, the reactively functionalized siloxane polymer, and the non-aromatic impact modifier can be added individually and combined in the mixing manifold to form the composition prior to extrusion.

Following formation of the molten mixture, the mixture can be conveyed under pressure to the spinneret 14 of the extruder apparatus 12, where it can be extruded through multiple spinneret orifices to form one or more fibers or filaments 9. Extrusion temperatures in the range of about 280° C. to about 340° C. can be employed, for instance in the range of about 290° C. to about 320° C. Following extrusion of the polyarylene sulfide composition to form the fibers or filaments, the undrawn fibers or filaments 9 can be quenched in a liquid bath 16 and collected by a take-up roll 18, for instance to form a multifilament fiber structure or fiber bundle 28. Take-up roll 18 and roll 20 can be within bath 16 and convey individual fibers or filaments 9 and the gathered fiber bundle 28 through the bath 16. Dwell time of the material in the bath 16 can vary, depending upon line speed, bath temperature, fiber size, etc. Following exit from the quenching bath, the fiber bundle 28 can pass through a series of nip rolls 23, 24, 25, 26 to remove excess liquid from the fiber bundle 28. Optionally, a lubricant can be applied to the fiber bundle 28. For example, a spin finish can be applied at a spin finish applicator chest 22. Following, the polyarylene sulfide fiber bundle can be drawn at temperatures in the range of 90° C. to 110° C. using conventional equipment having a draw zone designed to heat the fiber to the appropriate temperature. For example, in the embodiment illustrated in FIG. 1, the fiber bundle 28 can be drawn in an oven 43. Additionally, in this embodiment, the draw rolls 32, 34 can be either interior or exterior to the oven 43, as is generally known in the art. Subsequent to drawing the fiber bundle 28 a hot roll 40 or heated zone in a temperature range of 100° C. to about 200° C. can be used to at least partially crystallize the formed polyarylene sulfide fiber 30.

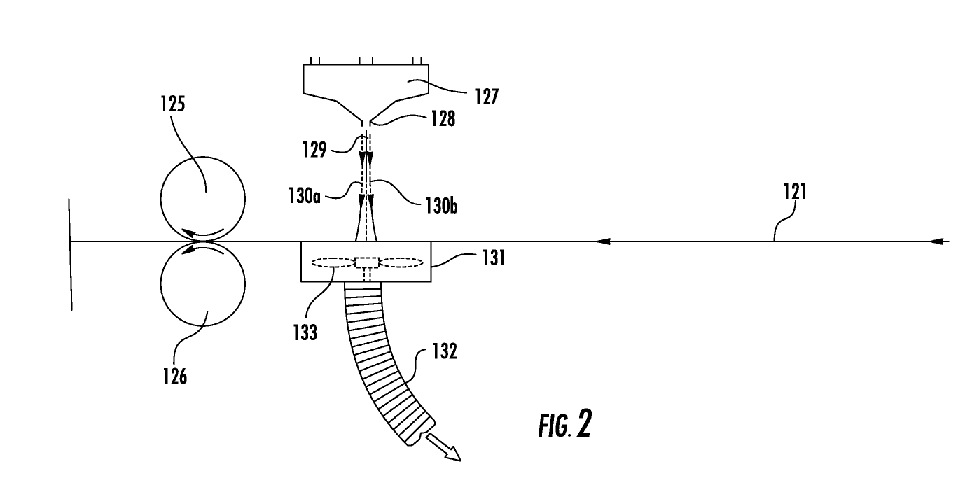

According to another embodiment, melt-blown fibers can be formed of the polyarylene sulfide composition. FIG. 2 illustrates one embodiment of a melt-blowing process 110 as may be utilized. The melt-blowing process 110 includes of extruding the polyarylene sulfide composition from an extruder 127 through a linear array of single-extrusion orifices 128 directly into a high velocity heated air stream defined generally between 130a and 130b. The rapidly moving hot air greatly attenuates the fibers 129 as they leave the orifices 128. The die tip is designed in such a way that the holes are in a straight line with high velocity air impinging from each side 130a, 130b. A typical die will have 10-20 mil (0.25-0.51 mm) diameter holes spaced at 20 to 50 per inch. The impinging high-velocity hot air attenuates the filaments and forms the desired microfibers. Typical air conditions range from about 200° C. to about 370° C. Immediately around the die, a large amount of ambient air is drawn into the hot air stream containing the fibers. The ambient air cools the hot gas and solidifies the fibers.

The discontinuous fibers may be deposited on a conveyor or takeup screen 121 fed through rolls 125, 126 to form a random, entangled web. The fibers can be directed to the conveyor 121 by use of a suction device 131 that utilizes, e.g., a fan 133 that draws air away via tubing 132. Under the proper conditions, the fibers can still be somewhat soft at laydown and will tend to form fiber-fiber bonds; that is, they will stick together. The combination of fiber entanglement and fiber-to-fiber cohesion generally produces enough entanglement so that the web can be handled without further bonding. The web may also be deposited onto a conventional spun but not bonded web to which the former is then thermally bonded.

According to another embodiment, the fibers may be deposited onto the conveyor or take-up screen 121 so as to avoid thermal bonding between the individual fibers. For example, the temperature of the high velocity gas stream and/or the distance from the extrusion orifices 128 to the conveyor 121 can be predetermined so as to avoid thermal bonding of the individual fibers. Following deposition, the fibers can be further processed, for instance by cutting or chopping so as to form staple fibers of shorter length, for instance less than about 100 millimeters, less than about 50 millimeters, or less than about 30 millimeters.

Staple fibers and filaments can be formed according to other known processes as well. For example, a spun-bonding process can be utilized in which a fiber is spun, optionally drawn, and deposited on the fiber forming fabric. Following formation of spunbond filaments, the filaments may be chopped to form staple fibers, though a spun-bonding process can also be utilized to directly form staple fibers, with no additional chopping or cutting operation necessary, as is known.

Fibers formed of the polyarylene sulfide composition can be utilized in a variety of applications including, without limitation, as battery separators, oil absorbers, filter media, hospital-medical products, insulation batting, and the like. By way of example, FIG. 3 illustrates a fibrous mat 312 comprising a plurality of polyarylene sulfide melt-blown fibers 314 as may be used to capture fine particles from a gas or liquid stream. For instance, a filter including fibers formed of the polyarylene sulfide composition can be utilized in filtering fuel, oil, exhaust, other fluids in an engine, e.g., an automotive engine, or in forming a filter bag, for instance as may be utilized with an industrial smokestack, Fibers formed of the polyarylene sulfide composition can also be utilized in forming insulation materials, such as insulative paper or fabrics in electrical components.

Of course, non-fibrous articles may also be formed from the polyarylene sulfide composition. Shaping processes for forming articles of the polyarylene sulfide composition can include, without limitation, extrusion, injection molding, blow-molding, thermoforming, foaming, compression molding, hot-stamping, pultrusion, and so forth. Shaped articles that may be formed may include structural and non-structural shaped parts that may be expected to encounter high temperature, high impact environments during use. For instance, automotive components such as automotive hoses, fuel tanks, electronic wires, cables, and so forth can be formed from the polyarylene sulfide composition.

Tubular members as may be utilized for carrying liquids or gases, and in one particular embodiment heated liquids or gases, may be formed from the polyarylene sulfide composition. For instance tubular members including hoses, pipes, conduits and the like can be formed from the polyarylene sulfide composition. In one embodiment, for instance, the polyarylene sulfide composition can be utilized in forming a blow molded hollow member

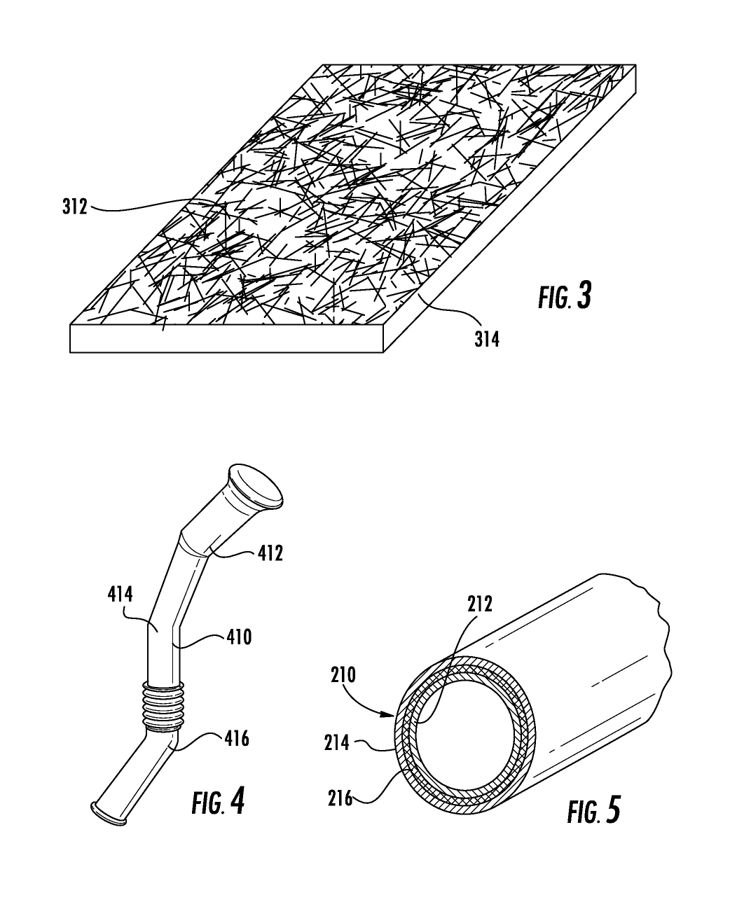

Referring to FIG. 4, one embodiment of a tubular member 410 formed from the polyarylene sulfide composition is shown. As shown, the tubular member 410 extends in multiple directions leading to a relatively complex shape. For instance, before the polyarylene sulfide composition can solidify, the angular displacements as shown in FIG. 4 can be formed into the part. The tubular member 10 includes angular displacement changes at 412, 414 and 416. The tubular member 410 may comprise, for instance, a part that may be used in the exhaust system of a vehicle.

According to one embodiment, the tubular member 410 can be formed according to a blow molding process. During blow molding, the polyarylene sulfide composition is first heated and extruded into a parison using a die attached to an extrusion device. When the parison is formed, the composition must have sufficient melt strength to prevent gravity from undesirably elongating portions of the parison and thereby forming non-uniform wall thicknesses and other imperfections. The parison is received into a molding device, generally formed of multiple sections that together form a three-dimensional mold cavity.

As can be appreciated, a certain period of time elapses from formation of the parison to moving the parison into engagement with the molding device. During this stage of the process, the melt strength of the polyarylene sulfide composition can be high enough such that the parison maintains its shape during movement. The polyarylene sulfide composition can also be capable of remaining in a semi-fluid state and not solidifying too rapidly before blow molding commences.

Once the molding device is closed, a gas, such as an inert gas is fed into the parison from a gas supply. The gas supplies sufficient pressure against the interior surface of the parison such that the parison conforms to the shape of the mold cavity. After blow molding, the finished shaped article is then removed. In one embodiment, cool air can be injected into the molded part for solidifying the polyarylene sulfide composition prior to removal from the molding device.

The polyarylene sulfide composition may be utilized in forming all manner of components as may be incorporated in a fluid handling system in addition to pipes and hoses such as, without limitation, flanges, valves, valve seats, seals, sensor housings, thermostats, thermostat housings, diverters, linings, propellers, and so forth. A fluid handling system can be utilized in carrying liquids or gases, for instance as may be beneficially utilized in an oil or gas pipeline system.

A tubular member that incorporates the polyarylene sulfide composition can be a multi-layered tubular member. FIG. 5 illustrates a multi-layered tubular member 210 as may incorporate the polyarylene sulfide composition in one or more layers of the tubular member. For example, at least the inner layer 212 can include the polyarylene sulfide composition that exhibits high impact strength characteristics under a wide temperature range and which is substantially inert to the materials to be carried within the tubular member 210.

The outer layer 214 and the intermediate layer 216 can include a polyarylene sulfide composition that is the same or different than the polyarylene sulfide composition described herein. Alternatively, other layers of the multilayer tubular member may be formed of different materials. For example, in one embodiment the intermediate layer 216 can exhibit high resistance to pressure and mechanical effects. By way of example, layer 216 can be formed of polyamides from the group of homopolyamides, co-polyamides, their blends or mixtures which each other or with other polymers. Alternatively, layer 216 can be formed of a fiber reinforced material such as a fiber-reinforced resin composite or the like. For example, a polyaramid (e.g., Kevlar®) woven mat can be utilized to form an intermediate layer 216 that is highly resistant to mechanical assaults.

Outer layer 214 can provide protection from external assaults as well as provide insulative or other desirable characteristics to the tubular member. For example, a multilayer hose can include an outer layer 214 formed from an adequate kind of rubber material having high levels of chipping, weather, flame and cold resistance. Examples of such materials include thermoplastic elastomer such as polyamide thermoplastic elastomer, polyester thermoplastic elastomer, polyolefin thermoplastic elastomer, and styrene thermoplastic elastomer. Suitable materials for outer layer 214 include, without limitation, ethylene-propylene-diene terpolymer rubber, ethylene-propylene rubber, chlorosulfonated polyethylene rubber, a blend of acrylonitrile-butadiene rubber and polyvinyl chloride, a blend of acrylonitrile-butadiene rubber and ethylene-propylene-diene terpolymer rubber, and chlorinated polyethylene rubber.

Outer layer 214 can alternatively be formed of a harder, less flexible material, such as a polyolefin, polyvinylchloride, or a high density polyethylene, a fiber reinforced composite material such as a glass fiber composite or a carbon fiber composite, or a metal material such as a steel jacket.

Of course, a multi-layer tubular member is not limited to three layers, and may include two, four, or more distinct layers. A multi-layer tubular member may further contain one or more adhesive layers formed from adhesive materials such as, for example, polyester polyurethanes, polyether polyurethanes, polyester elastomers, polyether elastomers, polyamides, polyether polyamides, polyether polyimides, functionalized polyolefins, and the like.

Multilayer tubular members may be made by conventional processes, such as, for example, co-extrusion, dry lamination, sandwich lamination, coextrusion coating, and the like. By way of example, in forming a three-layered tubular member 210 as illustrated in FIG. 5, the polyarylene sulfide composition, a polyamide composition, and a thermoplastic elastomer composition can be separately fed into three different extruders. The separate extrusion melts from those three extruders can then be introduced into one die under pressure. While producing three different tubular melt flows, those melt flows can be combined in the die in such a manner that the melt flow of the polyarylene sulfide composition forms the inner layer 212, that of the polyamide composition forms the intermediate layer 216, and that of the thermoplastic elastomer composition forms the outer layer 214, and the thus-combined melt flows are co-extruded out of the die to produce a three-layered tubular member.

Of course, any known tube-forming methods including blow molding methods are employable. For instance, in one embodiment, one or more layers of the multi-layered tubular member can be formed from a continuous tape, e.g., a fiber reinforced tape or ribbon formed according to a pultrusion formation method. A tape can be wrapped to form the tubular member or a layer of a multilayered tubular member according to known practices as are generally known in the art.

Storage containers as may be found in a fluid handling system may also advantageously incorporate the polyarylene sulfide composition. For instance, FIG. 6 schematically illustrates a fuel tank 512 as may be found in an automotive system. Fuel tank 512 can incorporate the polyarylene composition, for instance as a resistance layer 514 in the interior ‘C’ of the fuel tank. The fuel tank 512 can have a wall thickness ‘T’ including a blow molded outer layer and a thermoformed inner layer 514. For example, the polyarylene sulfide composition may be formed into a film and then thermoformed into the desired shape and/or size of the fuel tank interior. The film may be prepared using any known technique, such as with a tubular trapped bubble film process, flat or tube cast film process, slit die flat cast film process, etc. Regardless of the manner in which it is formed, the film may be thermoformed by heating the film to a certain temperature so that it becomes flowable, shaping the film within the fuel tank, and then trimming the shaped film to create the multi-layer fuel tank. A polyarylene sulfide thermoformed product is not limited to a fuel tank and may include, by way of example, a package, other types of containers, a tray (e.g., for a food product), an electrical connector, a circuit, a bottle, a pouch, a cup, a tub, a pail, a jar, a box, etc.

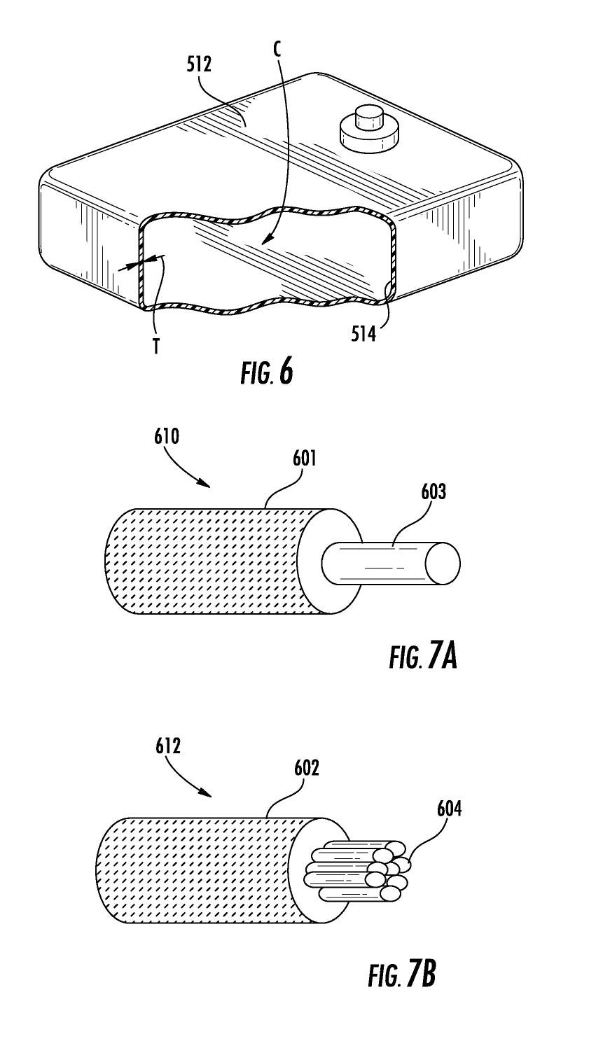

Still further, the composition may be employed in completely different environments, such as an electronic component. For example, and as illustrated in FIGS. 7A and 7B, the polyarylene composition can be utilized to form sheathing 601 around a wire 603 or sheathing 602 around a cable 604 for protection and encasement purposes. For instance, the polyarylene sulfide composition can be extruded by use of a sheathing machine around a wire or cable to form the protecting coating on the external surface of the wire/cable.

When considering an injection molding technique, the polyarylene composition can be utilized to form a variety of shaped products, and in one embodiment, parts having a small dimensional tolerance. For example, the composition may be molded into a part for use in an electronic component. The part may be in the form of a planar substrate having a thickness of about 100 millimeters or less, in some embodiments about 50 millimeters or less, in some embodiments from about 100 micrometers to about 10 millimeters. Alternatively, the part may simply possess certain features (e.g., walls, ridges, etc.) within the thickness ranges noted above. Examples of electronic components that may employ such a molded part include, for instance, cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, battery covers, speakers, camera modules, integrated circuits (e.g., SIM cards), etc.

Wireless electronic devices, however, are particularly suitable. Examples of suitable wireless electronic devices may include a desktop computer or other computer equipment, a portable electronic device, such as a laptop computer or small portable computer of the type that is sometimes referred to as “ultraportables.” In one suitable arrangement, the portable electronic device may be a handheld electronic device. Examples of portable and handheld electronic devices may include cellular telephones, media players with wireless communications capabilities, handheld computers (also sometimes called personal digital assistants), remote controls, global positioning system (“GPS”) devices, and handheld gaming devices. The device may also be a hybrid device that combines the functionality of multiple conventional devices. Examples of hybrid devices include a cellular telephone that includes media player functionality, a gaming device that includes a wireless communications capability, a cellular telephone that includes game and email functions, and a handheld device that receives email, supports mobile telephone calls, has music player functionality and supports web browsing.

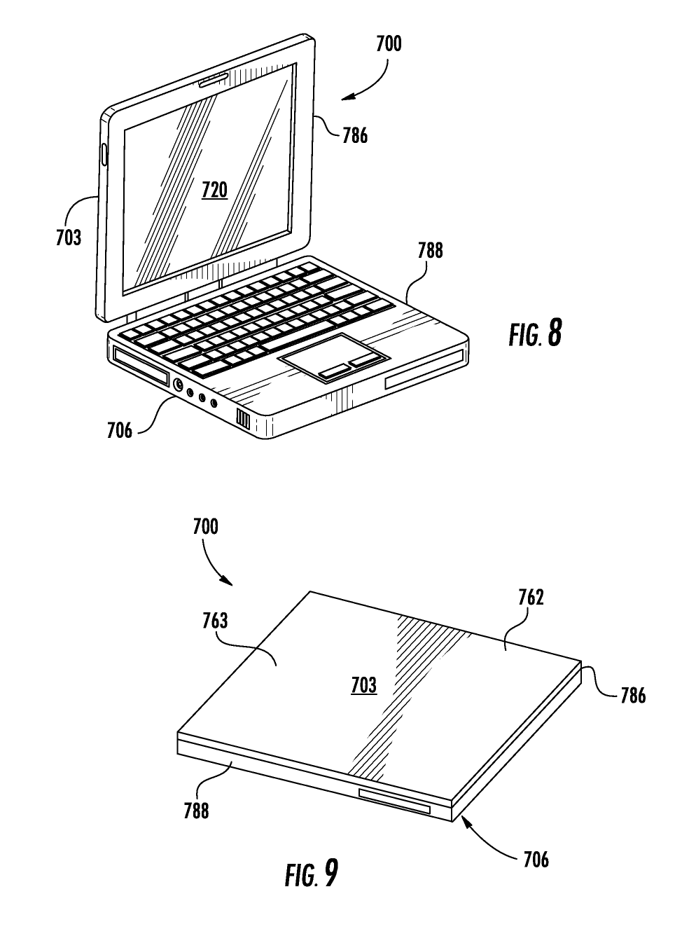

Referring to FIGS. 8-9, one particular embodiment of an electronic device 700 is shown as a portable computer. The electronic device 700 includes a display member 703, such as a liquid crystal diode (LCD) display, an organic light emitting diode (OLED) display, a plasma display, or any other suitable display. In the illustrated embodiment, the device is in the form of a laptop computer and so the display member 703 is rotatably coupled to a base member 706. It should be understood, however, that the base member 706 is optional and can be removed in other embodiments, such as when device is in the form of a tablet portable computer. Regardless, in the embodiment shown in FIGS. 8-9, the display member 703 and the base member 706 each contain a housing 786 and 788, respectively, for protecting and/or supporting one or more components of the electronic device 700. The housing 786 may, for example, support a display screen 720 and the base member 706 may include cavities and interfaces for various user interface components (e.g. keyboard, mouse, and connections to other peripheral devices). Although the polyarylene sulfide composition may generally be employed to form any portion of the electronic device 700, it is typically employed to form all or a portion of the housing 786 and/or 788. When the device is a tablet portable computer, for example, the housing 788 may be absent and the thermoplastic composition may be used to form all or a portion of the housing 786. Regardless, due to the unique properties achieved by the present invention, the housing(s) or a feature of the housing(s) may be molded to have a very small wall thickness, such as within the ranges noted above.

Although not expressly shown, the device 700 may also contain circuitry as is known in the art, such as storage, processing circuitry, and input-output components. Wireless transceiver circuitry in circuitry may be used to transmit and receive radio-frequency (RF) signals. Communications paths such as coaxial communications paths and microstrip communications paths may be used to convey radio-frequency signals between transceiver circuitry and antenna structures. A communications path may be used to convey signals between the antenna structure and circuitry. The communications path may be, for example, a coaxial cable that is connected between an RF transceiver (sometimes called a radio) and a multiband antenna.

The polyarylene sulfide composition can be utilized to form a variety of electronic components that may employ a molded part such as, for instance, cellular telephones, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, battery covers, speakers, camera modules, integrated circuits (e.g., SIM cards), etc.

Embodiments of the present disclosure are illustrated by the following examples that are merely for the purpose of illustration of embodiments and are not to be regarded as limiting the scope of the invention or the manner in which it may be practiced. Unless specifically indicated otherwise, parts and percentages are given by weight.

### Test Methods

Melt Viscosity:

The melt viscosity is reported as scanning shear rate viscosity. Scanning shear rate viscosity as reported herein was determined in accordance with ISO Test No. 11443 (technically equivalent to ASTM D3835) at a shear rate of 1200 s⁻¹ and at a temperature of 310° C. using a Dynisco 7001 capillary rheometer. The rheometer orifice (die) had a diameter of 1 mm, a length of 20 mm, an L/D ratio of 20.1, and an entrance angle of 180°. The diameter of the barrel was 9.55 mm±0.005 mm and the length of the rod was 233.4 mm.

Tensile Properties:

Tensile properties including tensile modulus, yield stress, yield strain, tensile break strain, tensile break stress, etc. were tested according to ISO Test No. 527 (technically equivalent to ASTM D638). Modulus and strength measurements were made on the same test strip sample having a length of 80 mm, thickness of 10 mm, and width of 4 mm. Testing temperature was 23° C., and testing speed was 5 mm/min.

Flexural Modulus, Flexural Stress, and Flexural Strain:

Flexural properties were tested according to ISO Test No. 178 (technically equivalent to ASTM D790). This test was performed on a 64 mm support span. Tests were run on the center portions of uncut ISO 3167 multi-purpose bars. Testing temperature was 23° C., and testing speed was 2 mm/min.

Izod Unnotched Impact Strength:

Unnotched Izod properties were determined according to ISO Test No. 180/1 U. Specimens were cut from the center of a multi-purpose bar using a single tooth milling machine. Testing temperature was 23° C.

Izod Notched Impact Strength:

Notched Izod properties were tested according to ISO Test No. 180/1A (technically equivalent to ASTM D256). This test was run using a Type A notch. Specimens were cut from the center of a multi-purpose bar using a single tooth milling machine. Testing temperature was 23° C.

Deflection Under Load Temperature (“DTUL”):

The deflection under load temperature was determined in accordance with ISO Test No. 75-2 (technically equivalent to ASTM D648-07). A test strip sample having a length of 80 mm, thickness of 10 mm, and width of 4 mm was subjected to an edgewise three-point bending test in which the specified load (maximum outer fibers stress) was 1.8 MPa. The specimen was lowered into a silicone oil bath where the temperature is raised at 2° C. per minute until it deflects 0.25 mm (0.32 mm for ISO Test No. 75-2).

Flammability:

The flame retarding efficacy is determined according to the UL 94 Vertical Burn Test procedure of the “Test for Flammability of Plastic Materials for Parts in Devices and Appliances”, 5th Edition, Oct. 29, 1996. The sample is subjected to a vertical burn test. The specimen is exposed to the flame for a period of ten seconds and then observed to determine the length of time required for the after flame to extinguish. The specimen is then re-exposed to the flame for another ten second period and again observed to determine time required for the afterflame to extinguish. After such time, the specimen is further observed to determine the amount of time the specimen afterglows.

Notched Charpy Impact Strength:

Notched Charpy properties are tested according to ISO Test No. ISO 179-1 (technically equivalent to ASTM D256, Method B). This test is run using a Type A notch (0.25 mm base radius) and Type 1 specimen size (length of 80 mm, width of 10 mm, and thickness of 4 mm). Specimens are cut from the center of a multi-purpose bar using a single tooth milling machine.

### Example 1

Several different reactively functionalized polydimethyl siloxanes were melt processed with a polyphenylene sulfide (PPS) (Fortron® 0214 available from Ticona Engineering Polymers) and an ethylene-acrylic ester-maleic anhydride terpolymer impact modifier (IM) (Lotader® AX 8840 available from Arkema, Inc.). The reactively functionalized polydimethyle siloxanes included amino terminated PDMS (Am-PDMS) and epoxy terminated PDMS (Ep-PDMS) (both available from Gelest, Inc.). Composition formulations are provided in the following table. All values are provided as weight percentages based upon the total weight of the composition.

| Sample No. | PPS | Am-PDMS | Ep-PDMS | IM |
|---|---|---|---|---|
| 1 | 100.0 | — | — | — |
| 2 | 97.0 | — | — | 3.00 |
| 3 | 85.0 | — | — | 15.0 |
| 4 | 85.0 | — | 1.50 | 13.50 |
| 5 | 97.0 | — | 3.00 | — |
| 6 | 85.0 | — | — | 15.0 |
| 7 | 85.0 | — | 0.5 | 14.5 |
| 8 | 85.0 | — | 1.5 | 13.5 |
| 9 | 75.0 | — | 1.5 | 23.5 |
| 10 | 85.0 | 1.5 | — | 13.5 |
| 11 | 75.0 | 1.5 | — | 13.5 |

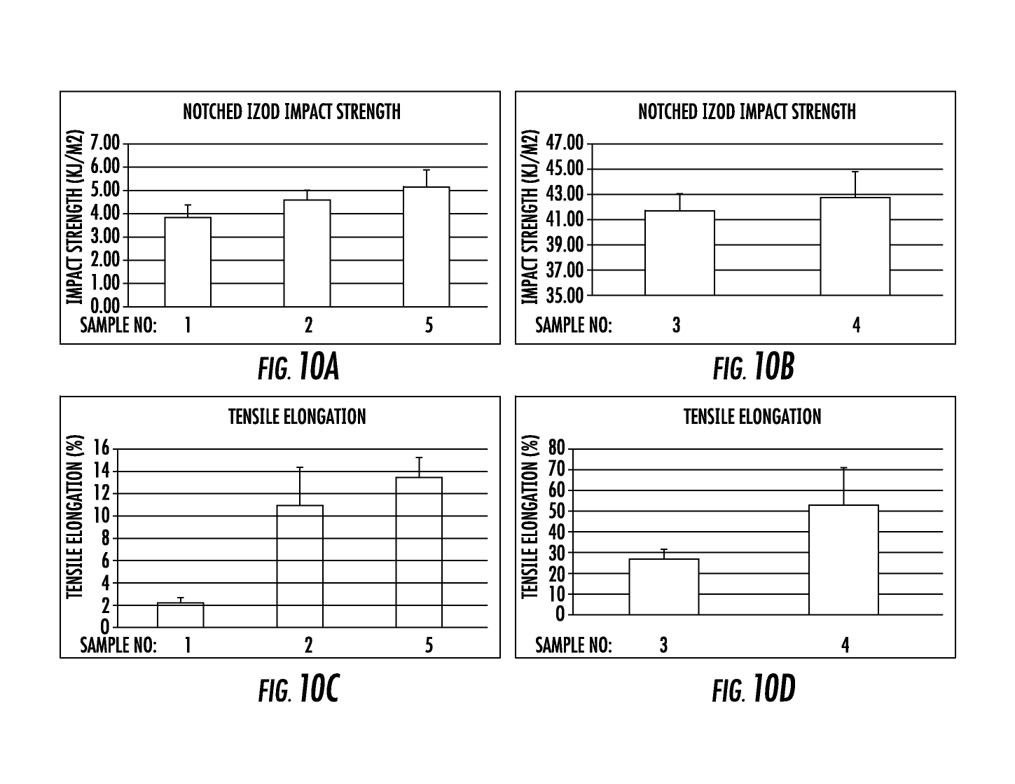

Testing results are provided in the following table as well as in FIGS. 10A-10D.

| | Sample No. | | | | | | | | | | |
|---|---|---|---|---|---|---|---|---|---|---|---|
| | 1 | 2 | 3 | 4 | 5 | 6 | 7 | 8 | 9 | 10 | 11 |
| Melt | 1162 | 1515 | 2572 | 2971 | 984 | 2551 | 2802 | 2858 | 3212 | 2737 | 4165 |
| Viscosity | | | | | | | | | | | |
| (poise) | | | | | | | | | | | |
| Tensile | 3650 | 3254 | 2321 | 2152 | 3448 | 2127 | 2263 | 2276 | 1965 | 2229 | 1616 |
| Modulus | | | | | | | | | | | |
| (MPa) | | | | | | | | | | | |
| Tensile | 69.39 | 70.06 | 47.41 | 46.47 | 68.6 | 41.16 | 47.73 | 49.14 | 47.36 | 46.32 | 39.77 |
| Break | | | | | | | | | | | |
| Stress | | | | | | | | | | | |
| (MPa) | | | | | | | | | | | |
| Tensile | 2.27 | 9.72 | 27.93 | 53.32 | 13.49 | 23.00 | 62.08 | 68.97 | 124.11 | 60.57 | 68.37 |
| Break Strain | | | | | | | | | | | |
| (%) | | | | | | | | | | | |
| Flexural | 3507 | 3209 | 2458 | 2406 | 3546 | — | — | — | — | — | — |
| Modulus | | | | | | | | | | | |
| (MPa) | | | | | | | | | | | |
| Flexural | 119.17 | 107.11 | 70.1 | 69.4 | 107.9 | — | — | — | — | — | — |
| Break | | | | | | | | | | | |
| Stress | | | | | | | | | | | |
| (MPa) | | | | | | | | | | | |
| Notched | 3.90 | 4.60 | 41.7 | 42.9 | 5.20 | — | — | — | — | — | — |
| Izod (kJ/m²) | | | | | | | | | | | |
| Unnotched | — | — | — | — | — | 28.80 | 32.20 | 30.90 | 53.9 | 41.4 | 51.20 |
| Izod (kJ/m²) | | | | | | | | | | | |
| DTUL (° C.) | 102.8 | 102.6 | 97.5 | 96.5 | 98.1 | — | — | — | — | — | — |

As can be seen, both impact strength and tensile elongation are improved upon the addition of as little as 1.5% epoxy modified polydimethyl siloxane. The mechanism for this improvement is believed to be due to the reaction between the polyarylene sulfide and the reactively functionalized polydimethyl siloxane, which can result in formation of copolymers that function as compatibilizers. This compatibilization can reduce the phase separation between the polyarylene sulfide and the non-aromatic impact modifiers.

### Example 2

Mercapto-functionalized polydimethyl siloxane (M-PDMS) was melt processed with a polyphenylene sulfide (PPS) (Fortran® 0214 available from Ticona Engineering Polymers). The impact modifier was either ethylene-acrylic ester-maleic anhydride terpolymer (Lotader® AX 8840 available from Arkerna, Inc.) or one of two polydimethyl siloxane impact modifiers: Genioplast® Pellet S (Gen-S) or Xiameter® (Xia). The compositions of the samples are described in the following table. All values are provided as weight percentages based upon the total weight of the composition.

| Sample No. | PPS | M-PDMS | Lotader | Gen-S | Xia |
|---|---|---|---|---|---|
| 12 | 95 | 0 | 0 | 5 | 0 |
| 13 | 85 | 0 | 0 | 15 | 0 |
| 14 | 95 | 0 | 5 | 0 | 0 |
| 15 | 95 | 1 | 0 | 0 | 4 |
| 16 | 95 | 4 | 0 | 0 | 1 |
| 17 | 95 | 0 | 0 | 0 | 5 |
| 18 | 85 | 3 | 0 | 0 | 12 |

Testing results are provided in the following table:

| | Sample No. | | | | | | |
|---|---|---|---|---|---|---|---|
| | 12 | 13 | 14 | 15 | 16 | 17 | 18 |
| Melt Viscosity | 1320 | 1024 | 1650 | 906 | 572 | 1210 | 549 |
| (poise) | | | | | | | |
| Tensile Modulus | 3161 | 2588 | 3295 | 2983 | 3119 | 3145 | 2580 |
| (MPa) | | | | | | | |
| Yield Stress (MPa) | 72.43 | 57.83 | 0 | 69.66 | 69.37 | 74.62 | 52.73 |
| Yield Strain (%) | 3.59 | 4.51 | 0 | 4.25 | 3.33 | 3.83 | 3.08 |
| Tensile Break | 71.68 | 56.5 | 64.58 | 62.06 | 66.89 | 73.7 | 52.04 |
| Stress (MPa) | | | | | | | |
| Tensile Break | 3.59 ± 0.59 | 11.62 ± 0.4 | 3.3 ± 0.7 | 6.75 ± 1.25 | 4.79 ± 1.75 | 4.02 ± 0.6 | 3.06 ± 0.44 |
| Strain (%) | | | | | | | |
| Notched Charpy | 2.6 ± 0.5 | 2.4 ± 0.6 | 2.8 ± 0.4 | 4.5 ± 0.8 | 2.8 ± 0.4 | 2.8 ± 0.5 | 2.8 ± 0.4 |
| (23° C.; kJ/m²) | | | | | | | |
| Notched Charpy | 2.7 ± 0.2 | 2.8 ± 0 | 3 ± 0.4 | 2.9 ± 0.1 | 2.8 ± 0.1 | 2.9 ± 0 | 2.4 ± 0.7 |
| (−30° C.; kJ/m²) | | | | | | | |

As can be seen, incorporation of the Xiameter® impact modifier at low percentage can improve the flexibility and room temperature impact resistance of the composition. Addition of the mercapto-functionalized PDMS improved the incorporation of the impact modifier into the composition.

While certain representative embodiments and details have been shown for the purpose of illustrating the subject invention, it will be apparent to those skilled in this art that various changes and modifications may be made therein without departing from the scope of the subject invention.

What is claimed is:

1. A polyarylene sulfide composition comprising:
a polyarylene sulfide;
a reactively functionalized siloxane polymer; and
a non-aromatic impact modifier.

2. The polyarylene sulfide composition according to claim 1, wherein the composition exhibits one or more of the following characteristics:
a tensile elongation of greater than about 30% as measured according to ISO Test No. 527,
a notched Izod impact strength of greater than about 40 kJ/m² as measured according to ISO Test No. 180/1 A;
an unnotched Izod impact strength of greater than about 30 kJ/m² as measured according to ISO Test No. 180/1 U,
a flexural modulus of less than about 2450 MPa as determined according to ISO Test No. 178,
a flexural break stress of less than about 70 MPa as determined according to ISO Test No. 178,
a tensile break strain of greater than about 25% as measured according to ISO Test No. 527,
meets the V-0 flammability standard at a thickness of 0.2 millimeters.

3. The polyarylene sulfide composition according to claim 1, wherein the polyarylene sulfide is reactively functionalized.

4. The polyarylene sulfide composition according to claim 1, wherein the polyarylene sulfide is a polyphenylene sulfide.

5. The polyarylene sulfide composition according to claim 1, wherein the reactive functionality of the siloxane polymer includes one or more of vinyl groups, hydroxyl groups, hydrides, isocyanate groups, epoxy groups, acid groups, halogen atoms, alkoxy groups, acyloxy groups, ketoximate groups, amino groups, amido groups, acid amido groups, amino-oxy groups, mercapto groups, alkenyloxy groups, alkoxyalkoxy groups, and aminoxy groups.

6. The polyarylene sulfide composition according to claim 1, wherein the siloxane polymer comprises polydimethyl siloxane.

7. The polyarylene sulfide composition according to claim 1, wherein the non-aromatic impact modifier is an ethylene copolymer or terpolymer, an ethylene propylene copolymer or terpolymer, or a silicone elastomer.

8. The polyarylene sulfide composition according to claim 1, wherein the non-aromatic impact modifier is modified with a mole fraction of from about 0.01 to about 0.5 of one of the following: an α, β unsaturated dicarboxylic acid or salt thereof having from about 3 to about 8 carbon atoms; an α, β unsaturated carboxylic acid or salt thereof having from about 3 to about 8 carbon atoms; an anhydride or salt thereof having from about 3 to about 8 carbon atoms; a monoester or salt thereof having from about 3 to about 8 carbon atoms; a sulphonic acid or a salt thereof; an unsaturated epoxy compound having from about 4 to about 11 carbon atoms.

9. The polyarylene sulfide composition according to claim 1, further comprising one or more additives.

10. The polyarylene sulfide composition according to claim 9, wherein the one or more additives include a fibrous filler or a mineral filler.

11. A fiber comprising the polyarylene sulfide composition according to claim 1.

12. A woven or nonwoven web comprising the fiber according to claim 11.

13. A tubular member comprising the polyarylene sulfide composition according to claim 1.

14. A component of a fluid handling or storage system comprising the polyarylene sulfide composition according to claim 1.

15. An electronic component comprising the polyarylene sulfide composition according to claim 1.

16. A sheathed wire or cable comprising the polyarylene sulfide composition according to claim 1.

17. A method for forming a polyarylene sulfide composition, the method comprising melt processing a polyarylene sulfide with a reactively functionalized siloxane polymer and a non-aromatic impact modifier.

18. The method according to claim 17, wherein the reactively functionalized siloxane polymer includes one or more of vinyl groups, hydroxyl groups, hydrides, isocyanate groups, epoxy groups, acid groups, halogen atoms, alkoxy groups, acyloxy groups, ketoximate groups, amino groups, amido groups, acid amido groups, amino-oxy groups, mercapto groups, alkenyloxy groups, alkoxyalkoxy groups, and aminoxy groups.

19. The method according to claim 17, wherein the siloxane polymer comprises polydimethyl siloxane.

20. The method according to claim 17, wherein the non-aromatic impact modifier is an ethylene copolymer or terpolymer or an ethylene propylene copolymer or terpolymer.

21. The method according to claim 17, wherein the non-aromatic impact modifier is modified with a mole fraction of from about 0.01 to about 0.5 of one of the following: an α, β unsaturated dicarboxylic acid or salt thereof having from about 3 to about 8 carbon atoms; an α, β unsaturated carboxylic acid or salt thereof having from about 3 to about 8 carbon atoms; an anhydride or salt thereof having from about 3 to about 8 carbon atoms; a monoester or salt thereof having from about 3 to about 8 carbon atoms; a sulphonic acid or a salt thereof; an unsaturated epoxy compound having from about 4 to about 11 carbon atoms.

22. The method according to claim 17, further comprising reacting the polyarylene sulfide with a disulfide compound.

23. The method according to claim 22, wherein the disulfide compound is reactively functionalized.

24. The method according to claim 17, further comprising carrying out a formation method with the polyarylene sulfide composition, the formation method comprising one or more of extrusion, injection molding, blow-molding, thermoforming, foaming, compression molding, hot-stamping, fiber spinning, and pultrusion.
